(19) United States
(12) Patent Application Publication
(10) Pub. No.: US 2010/0300131 A1
(43) Pub. Date: Dec. 2, 2010

(54) Cooling system

(76) Inventor: Urs Clavadetscher, St. Charles, IL (US)

Correspondence Address: LITMAN LAW OFFICES, LTD., PATENT LAW BUILDING, 8955 CENTER STREET, MANASSAS, VA, 20110, US

(21) Appl. No.: 12/457,163

(22) Filed: Jun. 2, 2009

(51) Int. Cl. G05D 23/32; F25D 17/04; F25D 17/06; F24F 13/20

(52) U.S. Cl. 62/158; 62/408; 62/419; 454/275

(57) ABSTRACT

The cooling system supplements the cooling of a walk-in cooler by injecting outside cold air via an outside air intake. The system includes air intake ductwork adapted to vent cold outside air into the walk-in cooler and air return ductwork that circulates the air to provide cross-flow of the injected cold air. Inline fans are connected to an interior thermostat. Motorized dampers are connected to a thermostat with an exterior temperature probe. The system thermostats are set slightly cooler than any pre-existing thermostat operating the pre-existing refrigeration system.

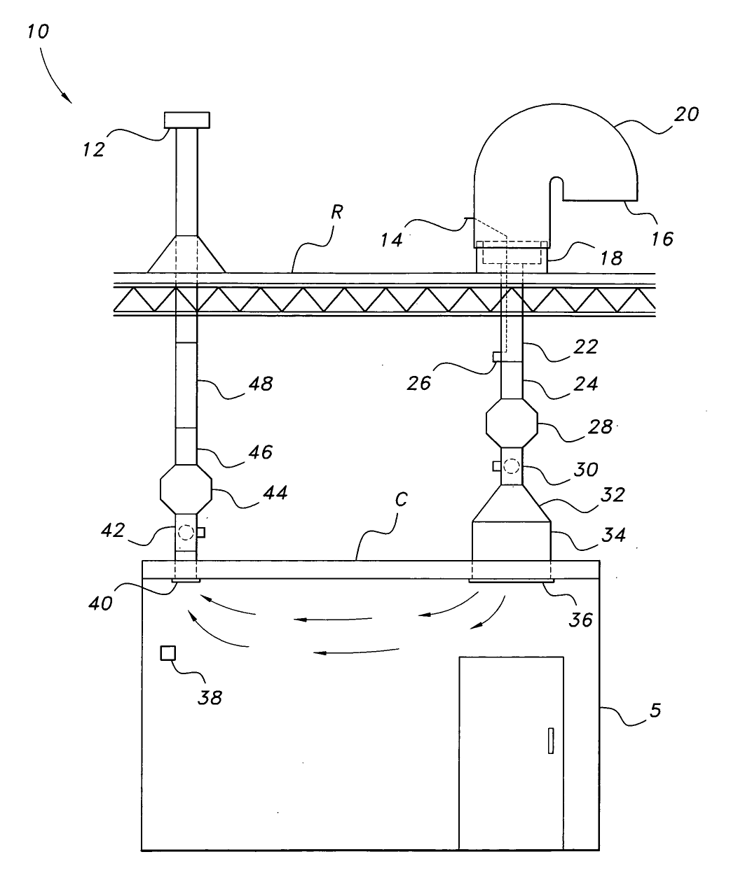

### BACKGROUND OF THE INVENTION

1. Field of the Invention

The present invention relates generally to refrigeration systems. More specifically, the invention is a supplemental cooling system having an outside cold-air intake to aid in the refrigeration of a walk-in cooler.

2. Description of the Related Art

Cooling economizers allow outside air to complement pre-existing cooling systems. If implemented properly, significant energy cost savings can be achieved due to reducing or eliminating the use of a refrigeration system's compressor and related electromechanical components. Proper implementation of a supplementary cooling system requires careful engineering design considerations with respect to placement of fans, dampers, thermostats, and the like. Therefore it would be most desirable to optimize the aforementioned design considerations in an effective economizing cooling system.

Thus, a cooling system solving the aforementioned problems is desired.

### SUMMARY OF THE INVENTION

The cooling system supplements the cooling of a walk-in cooler by injecting outside cold air via an outside air intake. The system includes air intake ductwork adapted to vent cold outside air into the walk-in cooler and air return ductwork that circulates the air to provide cross-flow of the injected cold air. Inline fans are connected to an interior thermostat. Motorized dampers are connected to a thermostat with an exterior temperature probe. The system thermostats are set slightly cooler than any pre-existing thermostat operating the pre-existing refrigeration system.

These and other features of the present invention will become readily apparent upon further review of the following specification and drawings.

### BRIEF DESCRIPTION OF THE DRAWINGS

The sole FIGURE is a block diagram of a cooling system according to the present invention.

### DETAILED DESCRIPTION OF THE PREFERRED EMBODIMENTS

The cooling system 10 uses cold outside ambient air to cool a walk-in cooler 5, thereby economizing operation of the conventional, pre-existing refrigeration system of the cooler room 5.

The cooling system 10 includes a thermostatic probe 14 mounted on a top outside duct 20. The probe 14 is connected to outside air thermostat 26 mounted on B-vent 22 to control operation of the air circulation system of the cooling system 10. Judicious choice of thermostatic set points can minimize cycling of the pre-existing refrigeration system while the cooling system 10 is in operation.

The air circulation portion of the cooling system 10 includes a top outside air intake duct 20, which is connected to air intake B-vent 22. A bird screen or an insect screen 16 covers the top outside air intake duct 20. An insulated roof curb 18 prevents air leakage of the connection of the outside duct 20 to the air intake B-vent 22. The air intake B-vent 22 is vertically disposed through the roof R of a building that houses the cooling room 5. An air intake B-vent slider 24 is connected to the end of the air intake B-vent 22. The air intake B-vent slider 24 is then connected to an air intake inline fan 28. The air intake fan 28 is connected to blow air into a motorized damper 30 when actuated by the system 10. The motorized damper 30 feeds into a transition duct 32, in which a HEPA filter 34 is enclosed. The transition duct 32 extends through the ceiling C of the cooling room 5 and terminates in an air diffuser 36 proximate a lateral end of the cooling room 5.

Proximate an opposite lateral end of cooling room 5 is an air return grille 40 leading into return ductwork extending through the ceiling C of the cooling room 5. The air return motorized damper 42 is connected to an air return inline fan 44, which is connected to an air return B-vent slider 46. The opposite end of the air return B-vent slider 46 is connected to another B-vent 48, which is vertically disposed through the roof R and capped with a cap 12, thus completing the air return circuit. The air intake damper 30 and the air return damper 42 open responsive to the temperature setting of outside air thermostat 26. Depending upon its temperature setting, an internal cooler thermostat with a time delay relay 38 energizes the inline intake fan 28 and the return inline fan 44 when the dampers 30 and 42 are opened. Preferably, the inside cooler thermostat 38 of system 10 is set slightly lower than any preexisting internal thermostats in the cooler room 5. When the system 10 is commanded off, the dampers 30 and 44 are closed to isolate the interior of walk-in cooler 5 from the outside air.

The above-described air circulation portion of the cooling system 10 is preferably adjusted to become operational when the outside temperature is 35° F. or lower. When the outside temperature reaches this condition, and the inside thermostat 38 calls for cooling (the temperature inside the cooler room rises above the temperature setting of the inside thermostat 38), the air circulation portion of cooling system 10 is energized to thereby supply cold outside air into the interior of the walk-in cooler room 5.

It is to be understood that the present invention is not limited to the embodiment described above, but encompasses any and all embodiments within the scope of the following claims.

I claim:

1. A cooling system, comprising:
a top outside duct adapted for mounting external to a structure housing a cooler room;
an outside ambient air temperature probe mounted on the top outside duct;
an air intake B-vent connected to the top outside duct, the B-vent being adapted for extending through a roof of the structure housing the cooler room;
an outside air thermostat mounted on the air intake B-vent, the outside air thermostat being connected to the outside ambient air temperature probe;
an air intake B-vent slider connected to the air intake B-vent;
an inline air intake fan connected to the B-vent slider;
a motorized damper connected to the inline air intake fan, operation of the motorized damper being controlled by the outside air thermostat so that the damper opens when ambient outdoor temperature falls below a temperature set on the outside air thermostat and the damper closes when ambient outdoor temperature rises above the temperature set on the outside air thermostat;
a transition duct connected to the damper, the transition duct being adapted for extending through a ceiling of the cooling room;
a diffuser connected to the transition duct for diffusing airflow from the transition duct into the cooler room;
air return ductwork adapted for extending through the ceiling of the cooling room;
an air return grille adapted for being disposed in the ceiling of the cooling room, the grille being connected to the air return ductwork;
an air return motorized damper connected to the return ductwork;
an air return inline fan connected to the air return damper;
an air return B-vent slider connected to the air return fan;
an air return B-vent extending upward from the air return B-vent slider, the air return B-vent being adapted for extending through the roof of the cooling room housing structure;
an inside air thermostat adapted for mounting in the cooler room, the inside air thermostat being connected to the inline air intake fan and the inline air return fan, the inside air thermostat having a temperature setting controlling operation of the inline air intake fan and the inline air return fan when the air intake and air return dampers are open; and
a cap disposed atop the air return B-vent.

2. The cooling system according to claim 1, further comprising an insulated roof curb disposed around a juncture of the outside duct to the air intake B-vent, the insulated roof curb preventing air leakage at the juncture.

3. The cooling system according to claim 1, further comprising a screen covering the top outside air intake duct.

4. The cooling system according to claim 1, wherein the inside air thermostat further comprises a time delay relay controlling the intake and return fans.
